(19) United States
(12) Patent Application Publication
(10) Pub. No.: US 2007/0016485 A1
(43) Pub. Date: Jan. 18, 2007

(54) Method for point of purchase retailing

(76) Inventors: Allison Drash, Pittsburg, PA (US); Erin Eisinger Katrincic, Brooklyn, NY (US)

Correspondence Address: John M. Skeriotis;Brouse McDowell, Ste. 500, 388 S. Main Street, Akron, OH, 44311-4407, US

(21) Appl. No.: 11/431,446

(22) Filed: May 10, 2006

Related U.S. Application Data
(60) Provisional application No. 60/679,584, filed on May 10, 2005.

(51) Int. Cl. G06Q 30/00; G07F 7/00

(52) U.S. Cl. 705/26; 705/27

(57) ABSTRACT

A method for educating consumers at the point of purchase for retail clothing and more specifically towards brassieres. The method includes presenting an associated shopper with informational media that can be used to educate the shopper on bra styles and sizing.

### I. BACKGROUND OF THE INVENTION

A. Field of Invention

This invention pertains to the art of methods for assisting consumers in selecting properly sized and fitted articles of clothing by providing pertinent instructional materials to the consumers at the point of purchase, which direct the consumer through a process and methodology for selecting properly sized and fitted articles of clothing.

B. Description of the Related Art

There are myriad ways that a consumer can select articles of clothing to make up a suitable wardrobe. Items may be selected solely based on style or material, manufacturer or price. In many instances, the characteristics of an item of clothing that lead to its purchase are irrelevant to whether the item is optimal for the buyer. However, in many instances, the failure to properly select an article of clothing can prove detrimental to the buyer. Improperly fitted shoes can result in long term back-pain. Improperly fitted helmets can result in serious head injury. Improperly fitted undergarments, such as bras, can prove uncomfortable to wear or unsuitable for their intended purpose. In the latter case, it is well know that the vast majority of women are wearing bras that are either the wrong size or improperly fitted or a combination of both.

Sometimes, particularly where clothing is custom made, retail outlets provide salespeople who are trained to take proper measurements of the buyer, provided with the tools to take those measurements, taught to follow through with making sure that the article of clothing is appropriately sized, and educated to check to make sure that the nuances of fit, apart from size, are met by the selected article. When all of these elements are in place, the consumer's satisfaction with their purchase is expected to be high. In reality, very few salespeople are adequately trained to perform the steps necessary for a careful fitting of an article of clothing. Salespeople have significant demands on their time, which may prevent them from taking a customer through the appropriate process of selecting clothing. Very often, salespeople do not have the appropriate tools to make sure that fit is accurate. Additionally, some items of clothing are inherently personal and prospective buyers may be uncomfortable allowing a salesperson to participate in the evaluative process.

While consumers may be able to educate themselves about the requirements for selecting properly fit and sized articles of clothing, by referring to articles in magazines or the internet, these sources of information are not available at retail outlets and consumers rarely carry the tools to make appropriate measurements of themselves. The result is uninformed customers making purchases of clothing without proper education or instruction, which can ultimately result in uncomfortable, dissatisfying and even unsafe clothing purchases.

What is needed is an appropriately tailored instructional campaign that is readily available to consumers at the point of purchase, which does not require salespeople, but which is capable of being incorporated with a sales staff. The methods taught in this invention will effectively educate customers on how to properly size and fit an article of clothing by means of a clear methodology and process.

### II. SUMMARY OF THE INVENTION

According to one aspect of the present invention, a new method for assisting consumers in selecting an article of clothing by providing a pertinent educational campaign at the point of purchase, is provided.

Another object of the present invention is to provide a method for assisting consumers in selecting an article of clothing that has the appropriate style for its intended use or purpose.

Yet another object of the present invention is to provide a method for assisting consumers in selecting an article of clothing that is appropriately sized to maximize protection, usefulness, and comfort.

Further, another object of the present invention is to provide a method for assisting consumers in selecting an article of clothing that is appropriately fitted to maximize protection, usefulness, and comfort.

Still yet, another object of the present invention is to educate consumers on the various styles that are available for a particular article of clothing.

Another object of the present invention is to provide suggestions on appropriately styled and sized articles of clothing based on information provided by the consumer.

Further, another object of the present invention is to assist consumers in purchasing appropriately styled brassieres having the right size and fit.

Yet another object of the present invention includes a point of purchase method for assisting a buyer in selecting an article of clothing, including:

providing an associated buyer interested in selecting one or more articles of clothing for purchase, wherein the buyer approaches an associated clothing sales outlet that sells the one or more articles of clothing; presenting at least a first informational medium to the associated buyer that describes the types of articles of clothing and the end usages of the types of articles of clothing, and, presenting a means for ascertaining the dimensions of the associated buyer with respect to the regions of the body that relates to the articles of clothing; and, suggesting the one or more articles of clothing for purchase.

Still another object of the present invention includes identifying the availability of the one or more articles of clothing for purchase.

Yet another object of the present invention includes providing an associated buyer interested in buying one or more articles of clothing, wherein the buyer approaches an associated retail clothing store that sells the one or more articles of clothing.

Still another object of the present invention includes presenting at least a first visual medium to the associated buyer that describes the types of styles of brassieres and the end usages for each of the styles of brassieres.

Still yet another object of the present invention includes providing a measuring tape for ascertaining the dimensions of the associated buyer with respect to the regions of the body that relates to the brassiere.

Another object of the present invention includes presenting at least a first visual medium to the associated buyer that describes the types of styles of brassieres and the end usages for each of the styles of brassieres, wherein the at least a first visual medium poses questions related to the associated buyers occasion for purchasing utilizes the one or more brassieres.

Still another object of the present invention includes presenting at least a first visual medium to the associated buyer that describes the types of styles of brassieres and the end usages for each of the styles of brassieres, wherein the at least a first visual medium poses questions related to the associated buyers occasion for purchasing utilizes the one or more brassieres, and, wherein the at least a first visual medium poses questions related to the associated buyer's physical measurements.

Yet another object of the present invention includes presenting a microprocessor-based informational display system to the associated buyer that describes the types of articles of clothing and the end usages of the types of articles of clothing.

Still another object of the present invention includes presenting a microprocessor-based informational display system to the associated buyer that describes the types of articles of clothing and the end usages of the types of articles of clothing, wherein the microprocessor-based informational display system prompts the user to answer questions related to the end usage of the articles of clothing.

Another object of the present invention includes automatically suggesting a specific article of clothing for purchase responsive to the answers entered into the microprocessor-based informational display system.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a pictorial representation of a point of purchase retail store with displayed informational media.

FIG. 1a is a flow chart of the method of the subject invention.

FIG. 2 is a representational brochure including information about styles of the articles of clothing.

FIG. 2a is a representational brochure including information about styles of the articles of clothing.

FIG. 2b is a representational brochure including information about styles of the articles of clothing.

FIG. 2c is a representational brochure including information about styles of the articles of clothing.

FIG. 3 is a representational brochure of information depicting fitting techniques for the articles of clothing.

FIG. 3a is a pictorial representation of the measuring tools for taking the fitting measurements of an associated shopper.

FIG. 4 is a representation of informational media educating point of purchase consumers about styles and sizing for the articles of clothing.

### IV. DESCRIPTION OF THE PREFERRED EMBODIMENT

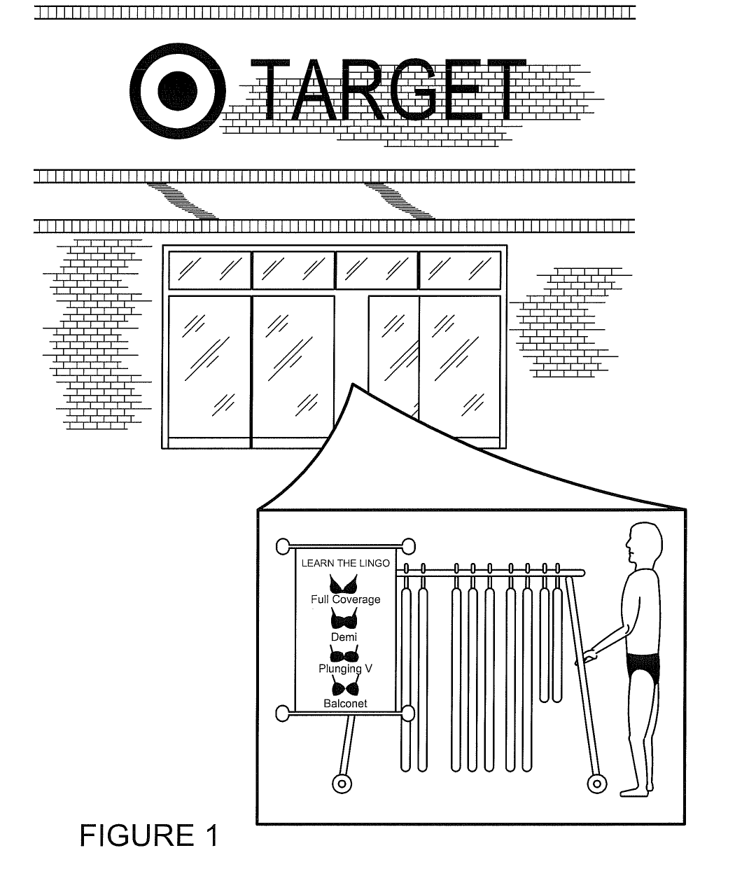

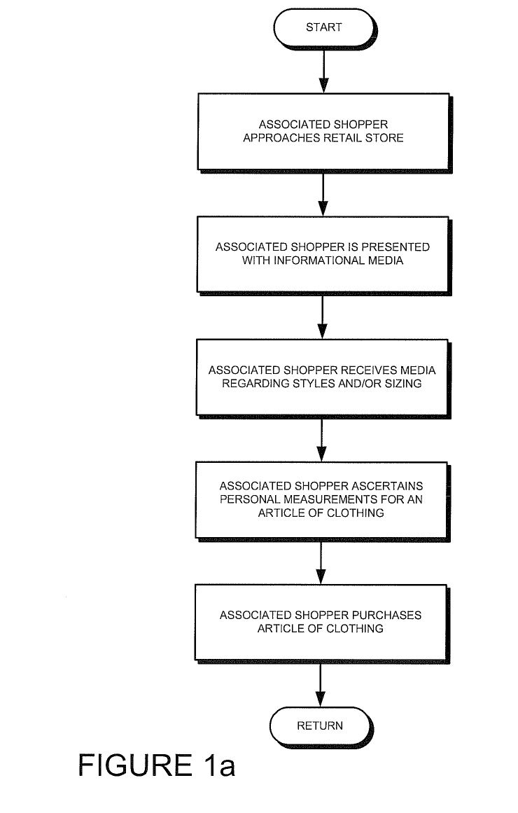

Referring now to the drawings wherein the showings are for purposes of illustrating a preferred embodiment of the invention only and not for purposes of limiting the same, FIGS. 1 through 1a depict the method of the present invention. The present invention is a system for assisting an associated purchaser of clothing in selecting an article of clothing following educational training that is provided at the point of purchase. The present invention may be incorporated in a variety of clothing store outlets, including internet clothing outlets, but in a preferred embodiment, the present invention may be incorporated in a clothing store that a prospective purchaser of clothing would physically visit and shop. The present invention may be incorporated in specialty stores that offer only selected clothing selections or in stores that provide a full array of clothing styles, types and options.

While the present invention is preferably employed in relation to purchasing clothing, and specifically, brassieres, the invention may be used in association with the purchase of any type of wearing apparel or apparatus that is fitted to the associated user and offer more than one style, which, independent of the dimensions of the apparel, affect the selection process. This, for example, may include helmets, which must be dimensionally fitted to the user, but which are also styled depending on the sport or activity for which the helmet will be worn.

With reference to FIGS. 1 and 1a, the steps of the present invention are shown. In the initial step, an individual approaches a clothing sales outlet that may sell an article of clothing having the characteristics of having to be dimensionally fitted to the associated user and having more than one style that may be selected from, which the selected style may be affected by the intended purpose of the article of clothing. The individual may approach a clothing sales outlet by physically visiting the clothing sales outlet or by reviewing written materials, such as catalogs, received from the clothing store outlet or by visiting the internet website, if any, of the clothing store outlet. The term “approach” includes any means by which an individual can select articles of clothing for purchase from the clothing sales outlet and substantially coincident with selecting articles of clothing, receive informational directions on style and fit, which informational directions are discussed in further detail below.

In this way, the clothing store outlet may be a physical store or it may be a mail order only facility or it may be an outlet having a presence only on the internet. The clothing store outlet may be any outlet that offers for sale, articles of clothing having the characteristics of having to be dimensionally fitted to the associated user and having more than one style that may be selected from, which the selected style may be affected by the intended purpose of the article of clothing.

As noted previously, in the preferred embodiment, the present invention pertains to the purchase of articles of clothing having the characteristics of having to be dimensionally fitted to the associated user and having more than one style that may be selected from, which the selected style may be affected by the intended purpose of the article of clothing. To have the characteristic of having to be dimensionally fitted to the associated user means the article of clothing may come in a variety of sizes or may be dimensionally adjustable and selecting the proper size of the article of clothing is dependant on taking at least one dimensional measurement of the associated user's body and correlating the dimensional measurement of the associated user's body to the size of the article of clothing.

To have the characteristic of having more than one style that may be selected from, which the selected style may be affected by the intended purpose of the article of clothing, means articles of clothing having the same size, may be routinely offered for sale in more than one style or variation and that the preferred style or variation selected by the associated user depends on one or more characteristics of the eventual application, use or purpose of the article of clothing. In one embodiment, for example, brassieres may have the characteristic of having more than one style that may be selected from, which the selected style may be affected by the intended purpose of the article of clothing. Some of the basic styles of Brassieres are demi, full coverage, plunging V, balconette or racerback styles. Of course, other styles are within the scope of this invention. Each of these styles may afford benefits to the associated user based on how the brassiere is to be worn and what affect the associated user wants the brassiere to impart.

With continued reference to FIGS. 1 and 1a, after the individual approaches a clothing sales outlet that may sell an article of clothing having the characteristics of having to be dimensionally fitted to the associated user and having more than one style that may be selected from, which the selected style may be affected by the intended purpose of the article of clothing, the individual may be provided with informational media that describes the various styles of the article of clothing that are available and which styles are suitable for various applications. In one embodiment, the informational media may be a paper media in the form of a brochure or poster. The brochures may be provided in a kiosk or on the sales counter. They may be provided in a fitting room. The informational media may be a page in catalog which offers for sale the articles of clothing. The informational media may be an electronic media, such as a computer terminal display located at the clothing outlet or a web page associated with the clothing outlet's internet site. The informational media may be an audio media, such as a recorded tape. The informational media may be any media selected with sound judgment.

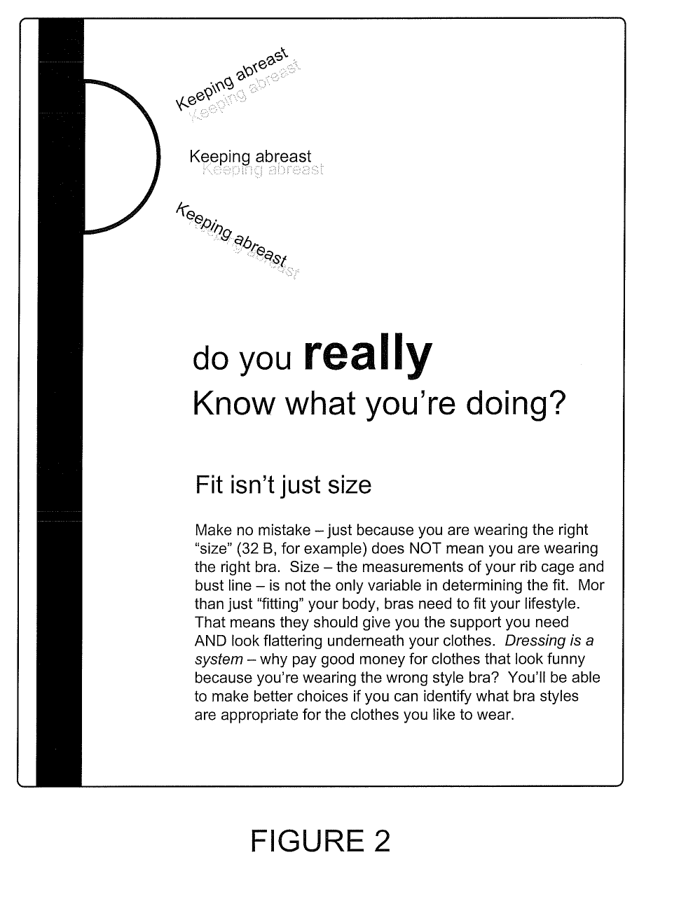

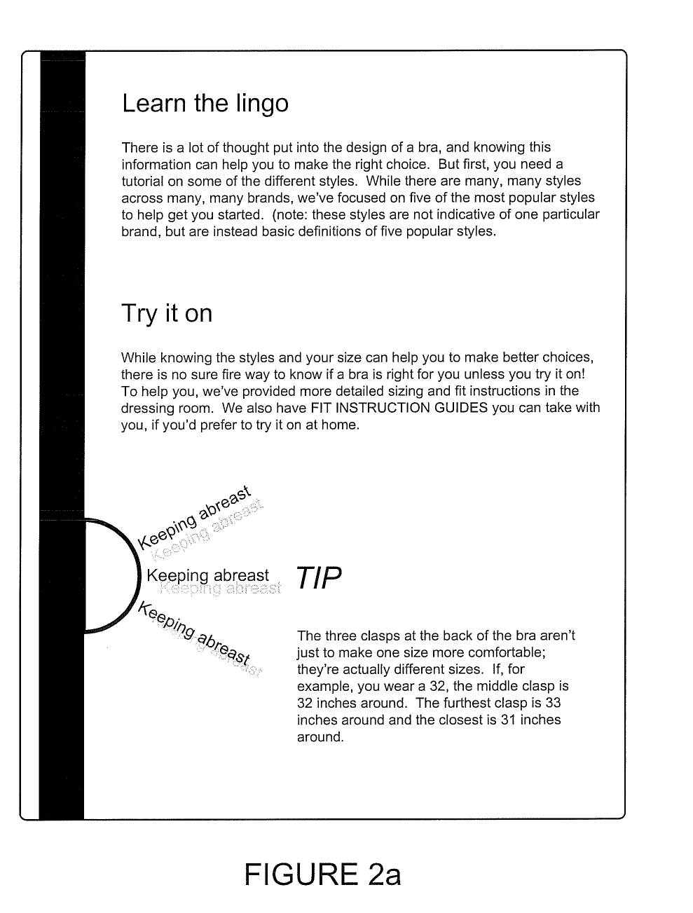

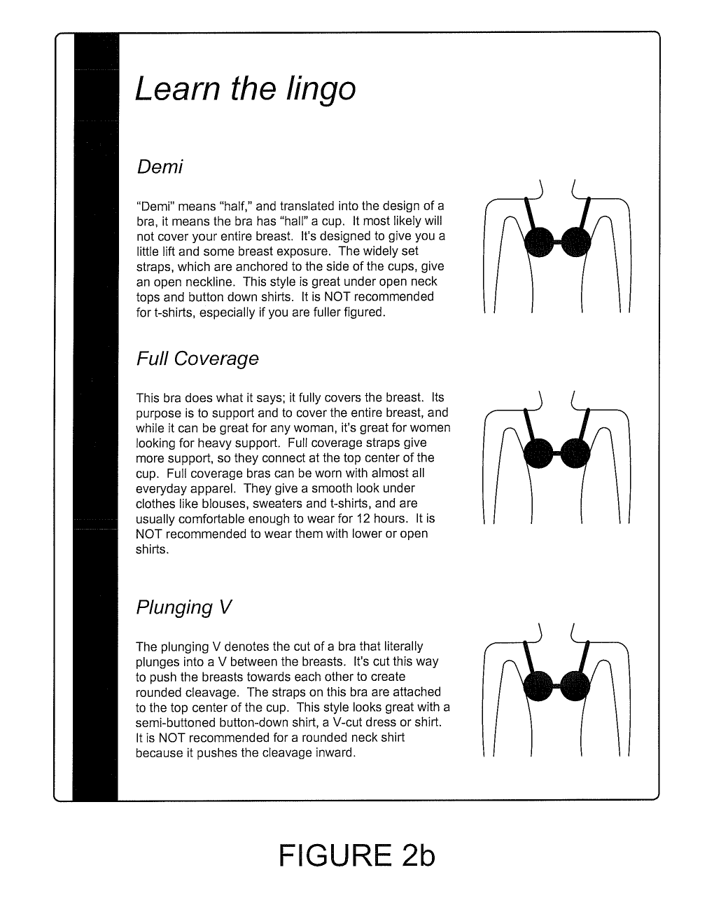

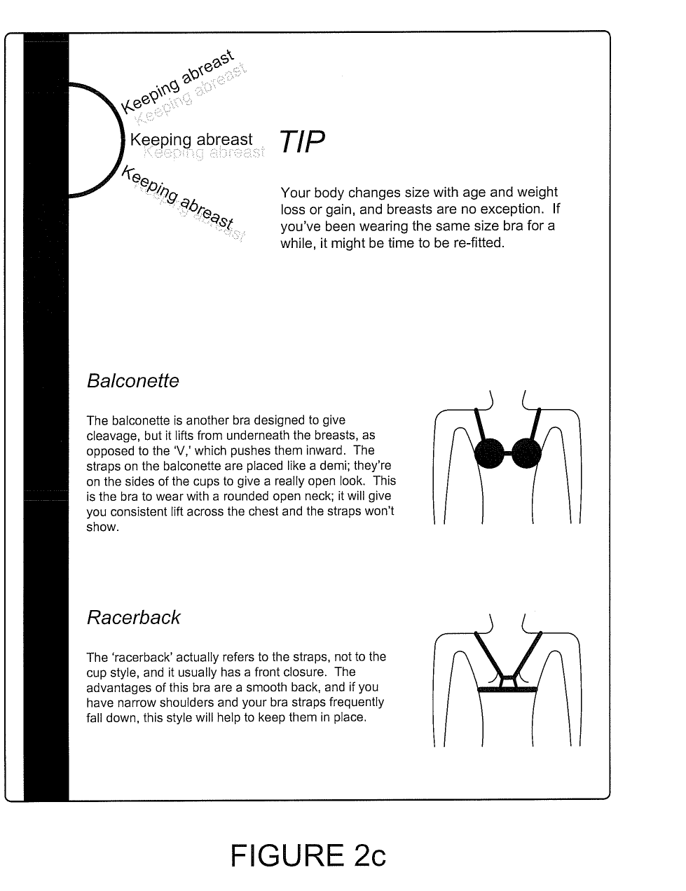

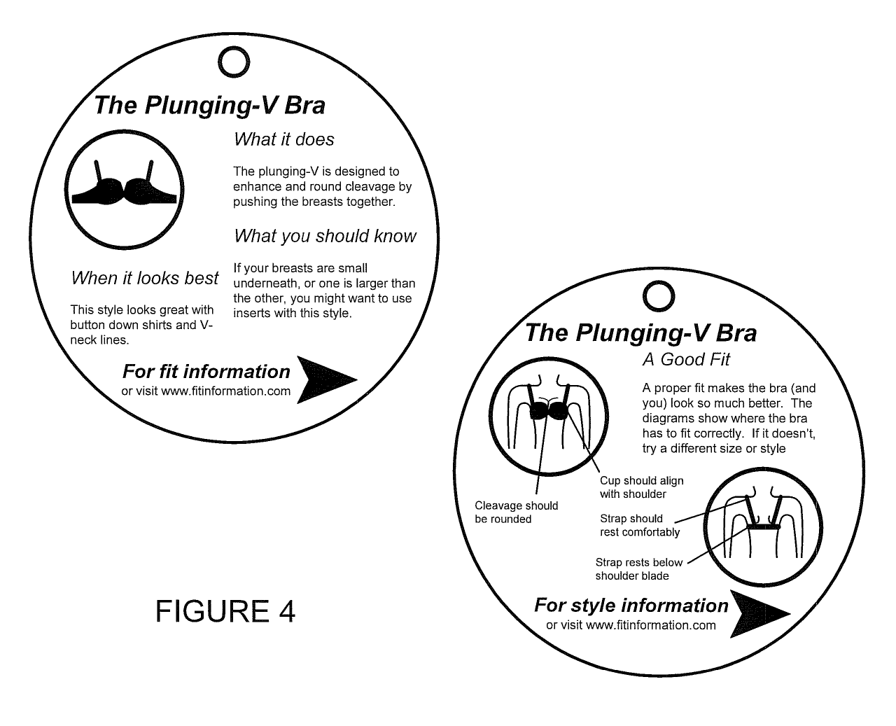

With reference to FIGS. 2 through 2c and 4, an example of a paper informational media is shown. The informational media may contain instructions on learning and understanding the verbiage and language used in describing the various styles of the articles of clothing. The informational media may contain pictures or photographs or other visual representations of the various styles of the articles of clothing. The informational media may describe the purposes or uses of each of the various styles of the articles of clothing. In this way, the informational media may describe how each style looks on or enhances the user, how it affects body shape, how it provides support or protection to the user, or how it relates to other articles of clothing that the user may wear. The informational media may also explain what styles are best suited to the purposes the user wants to put the articles of clothing to. In an alternative embodiment, the informational media may provide a series of questions directed to the user, wherein the answers to the questions direct the user to select a specific style of article of clothing or suggest a specific style.

The informational media may offer information on all styles of the article of clothing that exist or only the styles that are available at the particular retail clothing store offering the informational media.

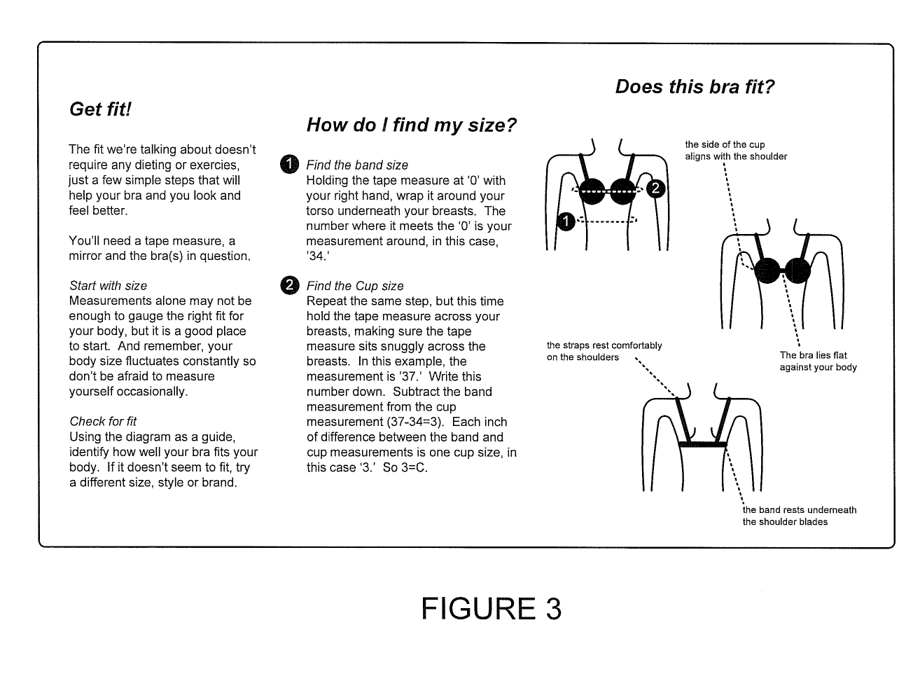

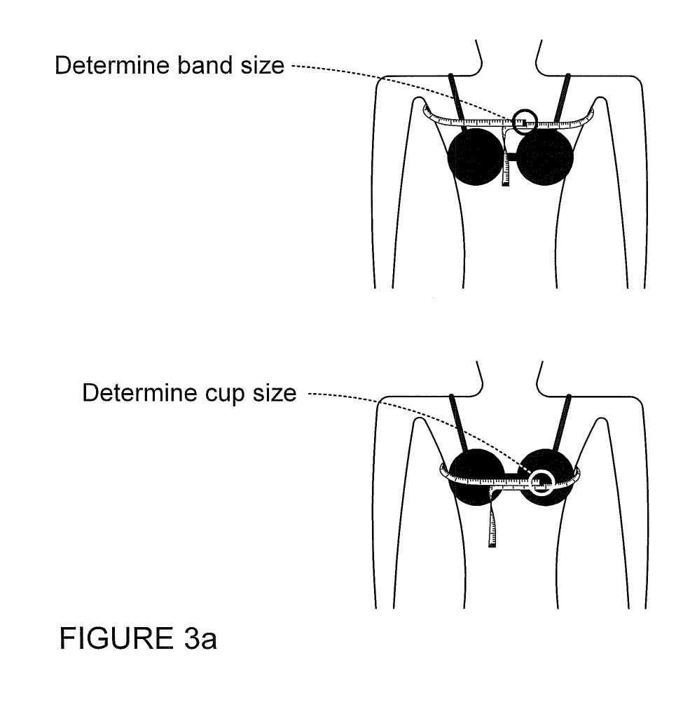

With continuing reference to FIGS. 3 and 3a, the invention also may include providing the associated buyer with information on selecting the proper sized article of clothing. The information on selecting the proper sized article of clothing may be a separate media from the informational media containing information on styles. The sizing information may be contained on a separate media, as shown in FIG. 3. The sizing media may be in any form selected with sound judgment, including, but not limited to, electronic media, paper media, or audio media. In one embodiment, the informational media on styles may be located near the articles of clothing and the sizing information may be provided in the dressing room where the associated user can take measurements. This embodiment is more conducive and applicable in physical clothing stores as opposed to mail-order stores and internet stores.

The sizing media may contain instructions on what components of the associated user should be measured, how to take the measurements and how to correlate the measurements to the article of clothing. The sizing media may also contain tips or instructions for making sure the article of clothing is properly worn by the user to maximize coverage, protection or comfort.

In one embodiment, the sizing media may be a sizing media associated with brassieres. The sizing media may contain instructions on how to measure the associated user in order to determine the proper sized brassiere for the user. The sizing media may also contain instructions on how to fit the brassiere on the user so as to maximize coverage, protection or comfort. The sizing media may contain photographs, pictures or other visual depictions showing the proper fit of the article of clothing. In one embodiment, the sizing media may instruct the user to try the brassiere on.

Referring again to FIG. 3a, the user may be provided with the measuring apparatus for measuring themselves in accordance with the instructions on the sizing media. In one embodiment, the measuring apparatus may be a tape measure. The measuring apparatus may be any apparatus that is appropriately selected for taking the measurements indicating on the sizing media.

In an alternate embodiment, the informational media on styles and the sizing media may be a microprocessor media. In this embodiment, the user may obtain instructions pertaining to the appropriate style and size of the article of clothing from a computer or kiosk terminal. The terminal may direct the user to select a style of the article of clothing based on the answers to questions posed to the user. These questions may inquire into the purpose for which the user is purchasing the article of clothing. The questions that also may be posed are questions regarding consumer's expectations for product; for example, what does a consumer want out of the clothing, i.e., what do they want it to do/be for them (other than just fit). The terminal may collect information on the dimensions of the user by asking the user to input this information. The dimensions requested may be based on the article of clothing being purchased. In this way, the terminal may provide informational media on style and sizing information for a variety of different articles of clothing. A user may, for example, find instructions and information on styles and sizes of brassieres and helmets, at one location.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A point of purchase method for assisting a buyer in selecting an article of clothing, the steps comprising:
providing an associated buyer interested in selecting one or more articles of clothing for purchase, wherein the buyer approaches an associated clothing sales outlet that sells the one or more articles of clothing;
presenting at least a first informational medium to the associated buyer that describes the types of articles of clothing and the end usages of the types of articles of clothing, and,
presenting a means for ascertaining the dimensions of the associated buyer with respect to the regions of the body that relates to the articles of clothing; and,
suggesting the one or more articles of clothing for purchase.

2. The method of claim 1, wherein the step of identifying the one or more articles of clothing, includes:
identifying the availability of the one or more articles of clothing for purchase.

3. The method of claim 2, wherein the step of providing an associated buyer interested in selecting one or more articles of clothing includes:
providing an associated buyer interested in buying one or more articles of clothing, wherein the buyer approaches an associated retail clothing store that sells the one or more articles of clothing.

4. The method of claim 1, wherein the step of providing an associated buyer interested in selecting one or more articles of clothing includes:
providing an associated buyer interested in selecting one or more brassieres for purchase; and,
wherein the step of presenting at least a first informational medium to the associated buyer, includes:
presenting at least a first visual medium to the associated buyer that describes the types of styles of brassieres and the end usages for each of the styles of brassieres.

5. The method of claim 4, wherein the step of presenting a means for ascertaining the dimensions of the associated buyer with respect to the regions of the body that relates to the articles of clothing, includes:
providing a measuring tape for ascertaining the dimensions of the associated buyer with respect to the regions of the body that relates to the brassiere.

6. The method of claim 4, wherein the step of presenting at least a first visual medium to the associated buyer that describes the types of styles of brassieres and the end usages for each of the styles of brassieres, includes:
presenting at least a first visual medium to the associated buyer that describes the types of styles of brassieres and the end usages for each of the styles of brassieres, wherein the at least a first visual medium poses questions related to the associated buyers occasion for purchasing utilizes the one or more brassieres.

7. The method of claim 6, wherein the step of presenting at least a first visual medium to the associated buyer that describes the types of styles of brassieres and the end usages for each of the styles of brassieres, wherein the at least a first visual medium poses questions related to the associated buyers occasion for purchasing utilizes the one or more brassieres, includes:
presenting at least a first visual medium to the associated buyer that describes the types of styles of brassieres and the end usages for each of the styles of brassieres, wherein the at least a first visual medium poses questions related to the associated buyers occasion for purchasing utilizes the one or more brassieres, and,
wherein the at least a first visual medium poses questions related to the associated buyer's physical measurements.

8. The method of claim 1, wherein the step of presenting at least a first informational medium to the associated buyer that describes the types of articles of clothing and the end usages of the types of articles of clothing, includes:
presenting a microprocessor-based informational display system to the associated buyer that describes the types of articles of clothing and the end usages of the types of articles of clothing.

9. The method of claim 8, wherein the step of presenting a microprocessor-based informational display system to the associated buyer that describes the types of articles of clothing and the end usages of the types of articles of clothing, includes:
presenting a microprocessor-based informational display system to the associated buyer that describes the types of articles of clothing and the end usages of the types of articles of clothing, wherein the microprocessor-based informational display system prompts the user to answer questions related to the end usage of the articles of clothing.

10. The method of claim 9, the step further comprising:
automatically suggesting a specific article of clothing for purchase responsive to the answers entered into the microprocessor-based informational display system.
